(19) United States
(12) Patent Application Publication
(10) Pub. No.: US 2014/0285044 A1
(43) Pub. Date: Sep. 25, 2014

(54) Closed System Self Propulsion Engine

(71) Applicant: Masud Harouny, San Dimas, CA (US)

(72) Inventor: Masud Harouny, San Dimas, CA (US)

(21) Appl. No.: 13/848,327

(22) Filed: Mar. 21, 2013

(51) Int. Cl. F03G 3/00; H02K 1/06; H02K 7/06

(52) U.S. Cl. CPC F03G 3/00; H02K 7/061; H02K 1/06
USPC 310/81

(57) ABSTRACT

With this patent design, I am challenging one of the foundations of modern engineering and physics, specifically a clause in the Conservation of Linear Momentum, which basically states that no object can gain linear momentum unless it pushes off of another object. This clause stems from Newton's Third Law of Motion, and is self evident for a point mass. However, I believe it to be impossible to account for all the infinite possible variations of propulsion machines that happen to have some dimension and real world properties. I think the people that drafted it, simply treated the change of momentum as a summation of forces on a point mass, and avoided the complexities that come with dimension and real bodies. This patent design will be a counter example for the aforementioned clause. It will open up the world up to new possibilities.

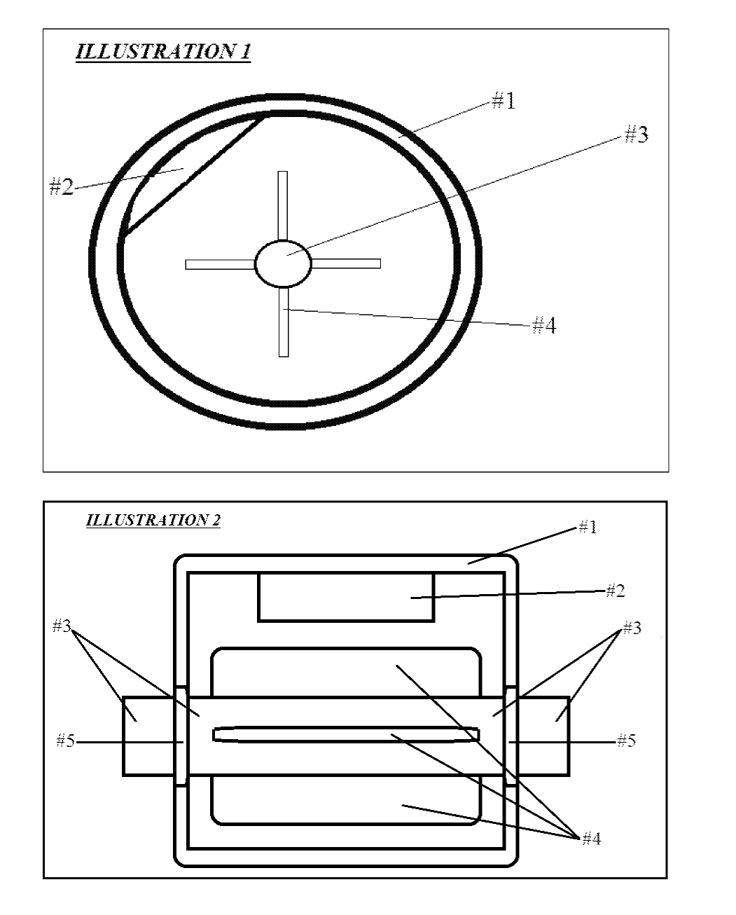

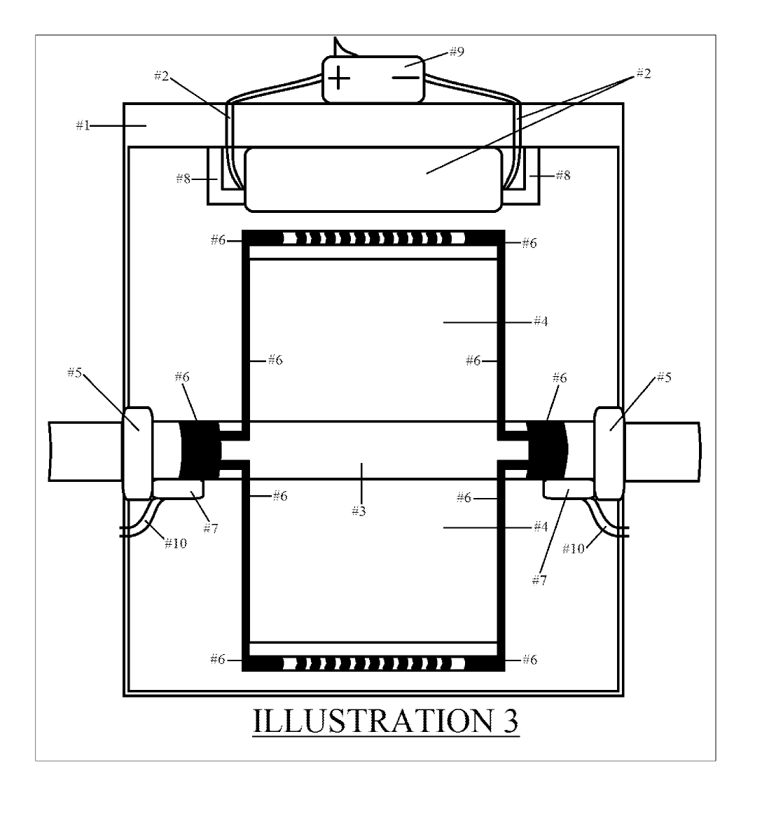

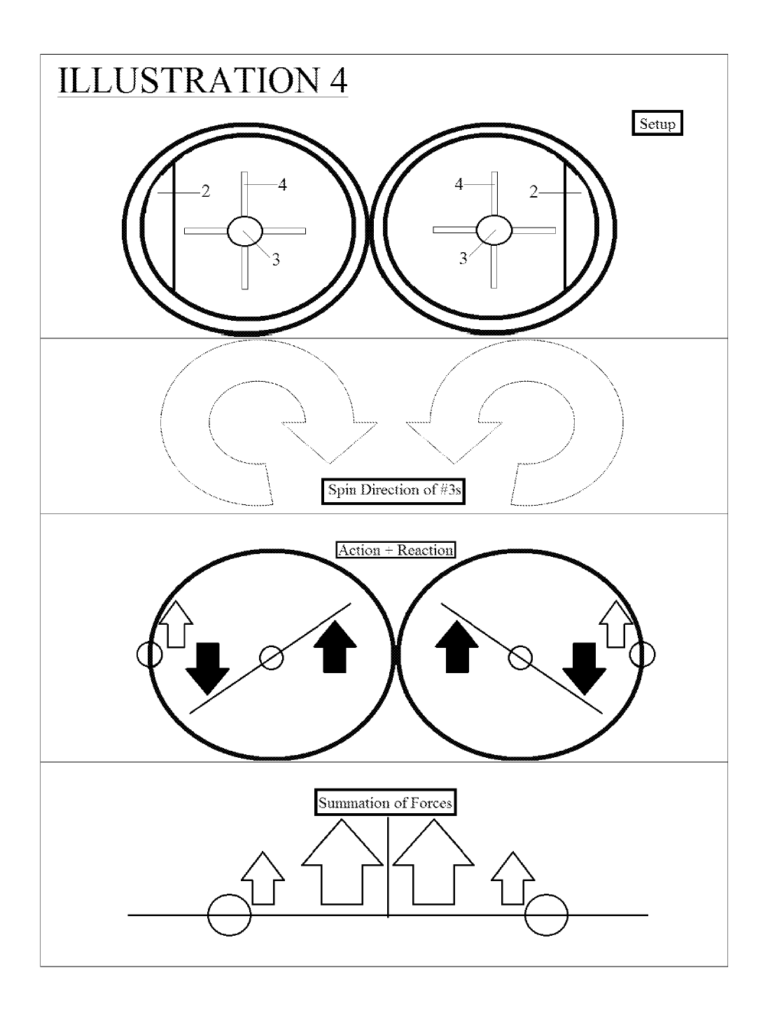

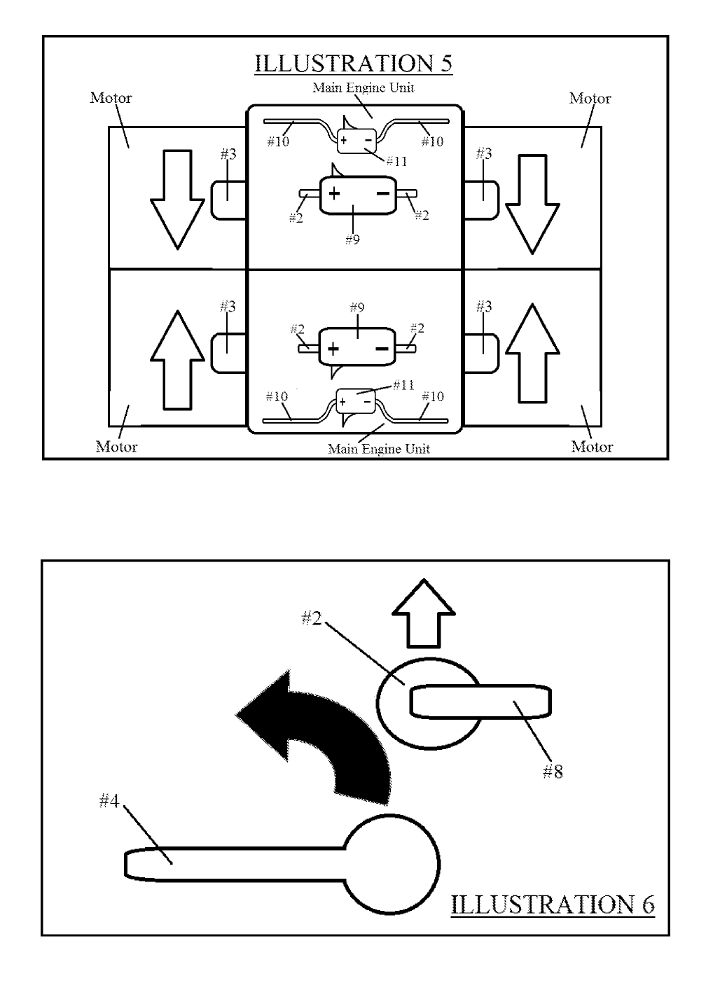

### BRIEF DESCRIPTIONS OF ILLUSTRATIONS

ILLUSTRATION 1: A side view of the Main Engine Unit that simply illustrates the locations of some of its basic components.

ILLUSTRATION 2: A front view of the Main Engine Unit that simply illustrates the locations of some of its basic components.

ILLUSTRATION 3: A front view of the Main Engine Unit that is more detailed than ILLUSTRATION 2. It illustrates its electrical components and setup of said components.

ILLUSTRATION 4: The top segment is simply a side view illustration that shows the setup of the Main Engine Units. The segment below that illustrates the spin direction, via arrows, of the #3s of the engines above it, respectively. Below that, there is visualization of the forces acting on the entire engine body. The action, which are the forces on the #2s, are displayed in white arrows. The circles underneath them represent the general area where the force is applied. The reactionary forces on the motors are displayed in black arrows. The circles and lines represent the pivot points. The left and right vectors for the forces obviously cancel each other out, and therefore, are not present. The last segment is a visualization of the summation of forces (action and reaction) on the body. The circles and lines represent the pivot point. The slight slants of the lines convey that the motors, and thus the engine bodies, are twisting.

ILLUSTRATION 5: A simple over the top view that shows the setup of the Main Engine Units. In this view, the locations of the motors are visible. Also visible, are the direction that the motors spin the #3s, via arrows inside the boxes that represent the motors.

ILLUSTRATION 6: An illustration showing how the two different electromagnets will act. The white arrow represents the force desired and the black arrow represents a general depiction of what the path of #3 will be like in relation to #2.

### DETAILED DESCRIPTIONS

### The Mechanics (Please Refer to ILLUSTRATION 4 and 6)

The #3s are spun by motors of some sort in the opposite direction of which the two #2s are facing each other. When the electromagnet of the #4 gets close to that of #2, they push on each other. The strength of the push is based on the strengths of the two electromagnets and the strength of the motor. The forces towards the outer end portions of the whole engine consist of the push on the #2 and the reactionary force on the motors. These forces cancel each other out, and what's left is a push forward from the middle of the engine.

### Setup of Electromagnets (Please Refer to ILLUSTRATION 3 and 6)

The #4 electromagnet will have electricity run from #11, through #10, and then #7, and then the #6 will carry it around #4 back to #7, and through #10 and back to #11. The #2 electromagnet will have it run from #9 to #2 and then back to #9. The #6 spiral lining around #4 must be in the same direction as #2 being coiled around #8. This is so the two electromagnets have the same polarity and repel each other. Electricity of both the #4 and #2 electromagnets must also run the same way for the same reason.

The positions of #2 and #5 should be in a place in such a way that will allow #4 to pass by #2 as closely as possible without touching it. This will ensure proper function for the Engine as well as maximum efficiency, since an electromagnet's repellent effectiveness is also based on proximity. Also, to ensure efficiency, there should be as much #4s that can be fit on to the engine.

I am claiming a new type of engine. It will be able push itself and whatever it is attached to, without the need of pushing off of something else. It consists of the fallowing components and configurations . . .

1. Main Engine Unit component, in which two of said components, serve as the core for the entire engine. Each Main Engine Unit consists of the fallowing components . . .
(Please refer to ILLUSTRATION 1, 2, AND 3)
#1: An outer shell which is made of material that has very low to zero electrical conductivity and magnetic properties.
#2: A traditional electromagnet that involves coiled wire around #8, and has the same directional flow of electricity as #6's spiral around the top of #4. It goes through #1 to attach, end to end, on #9.
#3: A rod made with material that has very low to zero electrical conductivity and magnetic properties. It jots out of #1 through #5.
#4: A sturdy, rigid and stiff sheet that is attached to and jots out of #3. It is rod like in shape at its outer end, and also has a small spatial gap near its end, both of which allows the #6 to spiral around it. When electricity runs through that aforementioned part of the #6 in the same direction as it does in #2, an electromagnet, with the same polarity as the #2, is created. The #4, itself is made out of material that has very low to zero electrical conductivity and magnetic properties.
#5: A rolling-element bearing that is attached to #1 and custom fitted for #3. It is made out of material with very low to zero electrical conductivity and magnetic properties.
#6: A smooth and thin lining for #3 and #4 that is made of material with high electrical conductivity and magnetic properties. It starts out on #3, touching #7, and branches into and out of all the #4s, acting like a parallel circuit. The lining can be on the surface and or underneath the surface of #3 and or #4.
#7: An electrical brush attached to the bottom of #5 and touching #6. If it hinders the rotational aspect of the bearing, #5, than it can be attached to #1.
#8: Some type of rigid and sturdy bar like apparatus that is attached on the inside of #1 and holds #2. It is made out of material with very low to zero electrical conductivity and magnetic properties.
#9: Some type of battery and switch (to turn on said battery and get electricity flowing) for #2 wires.
#10: Electrical wire attached from the two #7s to #11, end to end. It goes through #1 in order to do this.
#11: Some type of battery and switch that's attached to the outside of #1 on its side, and is connected to the #10s.

2. Two main engine units are attached side by side with their #2s on the outer sides of each other as seen on the top segment of ILLUSTRATION 4 and on ILLUSTRATION 5.

3. Four identical motors are attached to the ends of the Main Engine Units and their respective #3s as seen in ILLUSTRATION 5. The motors with the opposing spin (on their respective #3s) are also to be attached to each other, which can also be seen in ILLUSTRATION 5.
